(19) United States
(12) Patent Application Publication
(10) Pub. No.: US 2013/0069743 A1
(43) Pub. Date: Mar. 21, 2013

(54) HIGH-FREQUENCY WAVEGUIDE STRUCTURE

(71) Applicants: MARION KORNELIA MATTERS-KAMMERER, EINDHOVEN (NL); LORENZO TRIPODI, EINDHOVEN (NL)

(72) Inventors: MARION KORNELIA MATTERS-KAMMERER, EINDHOVEN (NL); LORENZO TRIPODI, EINDHOVEN (NL)

(73) Assignee: KONINKLIJKE PHILIPS ELECTRONICS N.V., EINDHOVEN (NL)

(21) Appl. No.: 13/611,766

(22) Filed: Sep. 12, 2012

Related U.S. Application Data
(60) Provisional application No. 61/535,410, filed on Sep. 16, 2011.

(51) Int. Cl. H01P 3/08; H01P 11/00; G01J 5/10

(52) U.S. Cl. 333/238; 250/349; 29/600

(57) ABSTRACT

For integration into a CMOS/BICMOS process, a high-frequency waveguide structure, a diode-bridge structure and an imaging/spectroscopy system and a method for manufacturing a high-frequency waveguide structure are provided, wherein a height of each of a first and a second conducting lines (11, 12) is higher than a width of each of the first and the second conducting lines (11, 12). The first and second conducting lines (11, 12) form a slotline waveguide, wherein the third conducting line (13) together with the first and the second conducting lines (11, 12) form a (co-)planar waveguide.

### FIELD OF THE INVENTION

The invention relates to a high-frequency waveguide structure, a diode-bridge structure, an imaging/spectroscopy system and a method for manufacturing a high-frequency waveguide structure.

### BACKGROUND OF THE INVENTION

With the high integration levels of modern integrated circuit (IC) processes integrated circuits get continuously denser. Along with this development, cross coupling of signals from one conductor to another by means of electric or magnetic field coupling is a serious problem and limits the miniaturization in analogue and also in digital applications. An increase of operating frequencies is a further factor resulting in stronger electric or magnetic field coupling. In a multi-conductor system with n conductors running in parallel, n-1 independent electromagnetic modes of propagation can be defined. Contrary to the signal power being present on only one of the conductors, the power of these independent modes is distributed over various conductors and propagates with a nearly unchanged planar field distribution in the axial direction of the conductors.

Multi-conductor systems have been proposed in the past and are described e.g. in B. C. Wadell, Transmission-line design handbook. Nevertheless, many of these multi-conductor layouts are not very suited for integration into complementary metal oxide semiconductor (CMOS/BICMOS) technology. In CMOS/BICMOS technology, the substrate is made of silicon that is a semiconductor with a significant conductivity. It can be seen as an additional conducting layer in a multi-conductor waveguide. Therefore, known layouts of multi-conductor waveguides will lead to high propagation loss and changed field patterns, when integrated into CMOS/BICMOS. Especially, slotlines with typically a wide field distribution cannot be integrated into CMOS/BICMOS adequately. The electric field is not mainly confined in-between the slotlines, but is also directed towards the conducting CMOS/BICMOS substrate. As a consequence, the known layouts are not suited for widespread, low cost commercial applications, e.g. CMOS/BICMOS.

To overcome the problem resulting from the silicon substrate of the CMOS/BICMOS another semiconductor-type is used. “130 GHz GaAs monolithic integrated circuit sampling head” (by R. A. Marsland et al.; Appl. Phys. Lett. 55 (6), pp. 592-594, August 1989) describes a waveguide structure connected to a GaAs diode bridge structure. The waveguide structure having a slotline mode and a co-planar waveguide mode and comprises two interconnecting structures respectively formed by a capacitor and a diode connected in series in-between. However, it is not possible to connect such a diode-bridge structure in a CMOS/BICMOS process to a slotline, and in particular to a balanced slotline, due to the high conductivity of the semiconducting silicon substrate of the CMOS/BICMOS process. By using a GaAs substrate there is no coupling due to the insulating character of the GaAs substrate.

WO 2009/013681 A1 discloses an integrated electronic terahertz imaging/spectroscopy device comprising a transmitter for transmitting electromagnetic radiation in the terahertz region to a sample and a receiver having a diode bridge structure connected to a high-frequency waveguide structure for receiving and analyzing electromagnetic radiation in the terahertz region from the sample. This terahertz spectroscopy device is based on a GaAs semiconductor substrate. However, GaAs substrates cause higher production costs, is toxic and regarded to be nature polluting, has a mechanically instable structure and a very high impurity density that limits the minimal size of IC structures to be fabricated. As a consequence, it is not suited for widespread, low cost commercial applications.

### SUMMARY OF THE INVENTION

In the view of the above disadvantages and problems in the prior art, it is an object of the present invention to provide a high-frequency waveguide structure, a diode-bridge structure, an imaging/spectroscopy system and a method for manufacturing such a high-frequency waveguide structure allowing inter alia an integration into a CMOS/BICMOS process.

The invention is based on the idea to enhance the confinement of the electric field between conducting lines formed on a substrate and to minimize the component of the electric field directed towards the substrate. By enhancing the contact area of the conducting lines facing each other and by adapting the distance between the conducting lines, the electric field may be mainly confined in-between the conducting lines. By further adapting the geometric parameters of the conducting lines, such as length, width and height, the impedance of the conducting lines may be adapted, preferably the height of each of the conducting lines is made higher than the width of each of the conducting lines. Additional conducting lines may be introduced in the high-frequency waveguide structure to increase the number of the independent propagation modes. By adapting the above-mentioned parameters, the losses due to the coupling of the conducting lines to the substrate and losses within the conducting line due to the skin effect can be reduced. As a result, the implementation of a waveguide structure for high frequencies in the sub-terahertz and/or terahertz range into CMOS/BICMOS technology or any other technology using any other substrate is possible. The terahertz range may preferably relate to frequencies starting from 100 GHz. The substrate can be a conducting, a semiconducting or an insulating material. In the proposed layout, the electric field is mainly confined in-between the conducting lines and the influence of the substrate on the transmission line parameters is strongly reduced, leading to low dispersion. Further, with the present invention, it is possible to co-propagate at least two signals without cross-coupling in highly integrated CMOS/BICMOS processes.

In a preferred embodiment, a first and second conducting line may be located in a thick metal layer to form a slotline waveguide, wherein a third conducting line may be located in the symmetry plane of the slotline waveguide on a different layer to form a co-planar waveguide using the slotline waveguide as a radiofrequency ground. Alternatively, the third conducting line may be located in the symmetry plane of the slotline waveguide in the same layer to form a planar waveguide using the slotline waveguide as radiofrequency ground. The first, second and third conducting lines may be embedded in a dielectric material above the substrate. This may lead to a co-propagation of two high-frequency signals without cross coupling between the conducting lines and the non-insulating substrate. As a further result, there may no current be induced by the slotline mode on the third conducting line.

Preferably, the surface area of the conducting lines of the slotlines facing each other is higher than the surface area of the conducting lines facing the substrate. This may lead to an enhanced coupling between the conducting lines and to a reduced coupling between the conducting lines and the substrate. The coupling may be a capacitive coupling and/or an inductive coupling. Alternatively or additionally, different dielectric materials having different dielectric constants may be formed between the conducting lines and the substrate and/or in-between the conducting lines to increase the effect.

Preferably, a dielectric material having a higher dielectric constant is located in-between the conducting lines to enhance the coupling between the conducting lines and a dielectric material having a lower dielectric constant is located between the substrate and the conducting lines to reduce the coupling between the substrate and the conducting lines.

Preferably, each of the first and the second conducting lines have a width of 1 to 5 μm along the first layer and perpendicular to the wave guiding direction. Preferably, each of the first and the second conducting lines have a height of 2 to 10 μm perpendicular to the first layer and perpendicular to the wave guiding direction, wherein the width may be smaller than the height.

Preferably, the first and the second conducting lines of the high-frequency waveguide structure may be made of Cu or an alloy thereof due to its high conductivity.

According to a further aspect of the present invention, a high-speed diode-bridge connected to the high-frequency waveguide structure is provided. A first interconnecting structure is connected between the first conducting line and the third conducting line and comprises a first diode connected with its cathode to the third conducting line and a first capacitor connected in series. A second interconnecting structure between the second conducting line and the third conducting line comprises a second diode connected with its anode to the third conducting line and a second capacitor connected in series.

Preferably, the first and the second diodes are Schottky diodes to assure fast switching of the first and the second diode.

Preferably the first and the second capacitors may be located on two intermediate layers under the first and the second conducting lines, respectively to thereby use the short distance to the substrate to realize the diode bridge structure without using long connection distances increasing the inductivity.

Furthermore, the first and the second diodes may be located in the substrate under the first and the second conducting lines, respectively. By this the connection length of the diode bridge is reduced. Additionally the connection between the first and the second diodes and the third conducting line could be kept short.

According to another aspect of the present invention, an imaging/spectroscopy system for spectroscopy in the sub-terahertz and/or terahertz band is provided. Such imaging/spectroscopy devices are used for analyzing a sample by using electromagnetic radiation in the sub-terahertz and/or terahertz region. The system comprises a transmitter for transmitting electromagnetic radiation in the sub-terahertz and/or terahertz region to the sample and a receiver comprising a high-frequency generator and a diode bridge structure as described above for receiving and processing electromagnetic radiation in the sub-terahertz and/or terahertz region from the sample.

Preferably, the receiver may comprise an high-frequency generator, which may be realized as an extreme wideband generator, for generating a signal with a very wide spectral content. The high-frequency generator may comprise a nonlinear transmission line. The non-linear transmisson line may reshape a sinusiodal signal from an oscillator by generating numerous harmonics having higher frequencies and may therefore generate a shockwave signal having a wide spectral content from 5 to 500 GHz.

Preferably, the high-frequency generator including the non-linear transmission line of the receiver is connected to a high-frequency waveguide structure as described above.

According to a further aspect of the invention a method for manufacturing a high-frequency waveguide structure is provided, comprising the steps of: providing a substrate and a dielectric material on the substrate; providing a thick metal layer in a first layer on the dielectric material; processing a first and a second conducting line by structuring the thick metal layer, wherein a height of each of the first and a second conducting lines is higher than the width of each of the first and a second conducting lines.

Additionally, a third conducting line is provided in the symmetry plane between the first and the second conducting lines and in the first layer or in a second layer above or below the first layer.

The imaging/spectroscopy system may be used in the field of medical or biological imaging, environmental sensing, security monitoring, food-safety analysis, as well as non-destructive testing in industrial processes and chemical analysis of compounds. Even if commercial applications are already available, the size and costs of current instruments are high. Furthermore, the technology required for implementing such imaging/spectroscopy device is very sophisticated due to the required use of substrates using GaAs. With this invention, terahertz spectrometry becomes available also in CMOS/BICMOS technology and will thus facilitate a reliable, low cost truly mobile technology. Such costs reduced, fully integrated terahertz spectrometers could be used in medicine and biology for a substance identification and analysis. Such low costs spectrometers could be provided to any policeman for drugs detections or to detect specific substances in any customs office. Also on airports, inoffensive substance such as talcum powder could be distinguished from other, forbidden substance. Also applications in the pharmaceutical industry are possible. The system might also be used for imaging biological tissue, such as human skin in order to, for instance, detect skin diseases.

### BRIEF DESCRIPTION OF THE DRAWINGS

FIG. 1 shows a high-frequency waveguide structure according to a first embodiment of the present invention.

FIG. 2 shows a high-frequency waveguide structure according to a second embodiment of the present invention.

FIG. 3a shows a diode bridge structure according to an embodiment of the present invention.

FIG. 3b shows a partial circuit diagram of the diode bridge structure according to FIG. 3a.

FIG. 4a shows an imaging/spectroscopy system according to an embodiment of the present invention.

FIG. 4b shows an imaging/spectroscopy system according to an embodiment of the present invention

### DETAILED DESCRIPTION OF EMBODIMENTS

### High-Frequency Waveguide Structure

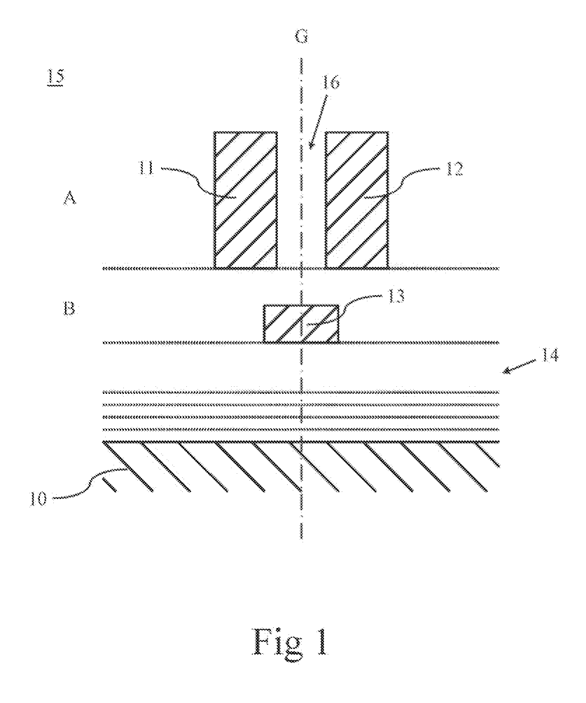

FIG. 1 shows a cross-sectional view of a high-frequency waveguide structure according to a first embodiment of the present invention. In this embodiment, all components of the high-frequency waveguide structure are integrated in a CMOS/BICMOS process.

The high-frequency waveguide structure comprises a substrate 10, a first and a second conducting line 11 and 12 located in a first layer A on the substrate 10 and a third conducting line 13 located in the symmetry plane between the first and the second conducting lines 11 and 12 in a second layer B below the first layer A. Each of the first and second conducting lines 11 and 12 have a width w which is smaller the height h of each of the first and second conducting lines 11 and 12. The width w of each of the first and the second conducting lines 11 and 12 is a dimension along the first layer A and perpendicular to the waveguiding direction and the height h of each of the first and the second conducting lines 11 and 12 is another dimension perpendicular to the first layer A and perpendicular to the waveguiding direction. Here the first and the second conducting lines 11 and 12 and the third conducting line 12 are arranged, such that the coupling between the first and the second conducting lines 11 and 12 is higher than the coupling between the first or the second conducting lines 11 or 12 to the third conducting line 13. And the coupling between the first and the second conducting lines 11 and 12 is higher than the coupling between the first or the second conducting lines 11 or 12 to the substrate 10. The coupling relates in particular to a capacitive coupling and/or an inductive coupling. The first and the second conducting lines 11 and 12 form a first high-frequency waveguide for a slotline mode (SL-mode), wherein the first and the second conducting lines 11 and 12 are at different radio frequency (RF) potential. Signal propagation in the slotline mode is possible. In particular, a multi-signal propagation is possible, comprising a balanced slotline mode, where the electric field crosses zero field strength in the symmetry plane G between the first and second conducting line 11 and 12, i.e. the electric field is substantially zero in the symmetry plane G. In this case, the third conducting line 13 can form an uncoupled co-planar waveguide mode with the first and second conducting lines 11 and 12 as RF ground, co-propagating with the slotline mode.

The first and the second conducting lines 11 and 12 are preferably made by structuring a thick metal layer, which is located on a dielectric material. Thus, there is a portion 14 comprising a dielectric material between the substrate 10 and the first and the second conducting lines 11 and 12. Also between the first and the second conducting lines 11 and 12 there is a dielectric material 16 which might have the same or a different dielectric constant compared to the dielectric material in the portion 14 between the substrate 10 and the first, second and third conducting lines 11, 12 and 13. Due to the thickness of the thick metal layer, the height h is comparably high and the electric field of the slotline waveguide is strongest in-between the first and the second conducting lines 11 and 12. The third conducting line 13 being located in the symmetry plane in the second layer B below the first layer A hardly influences the slotline mode of the first waveguide as there is no current induced by the slotline mode on the third conducting line 13. Furthermore, due to the strong confinement of the electric field in-between the first and the second conducting lines 11 and 12, the silicon substrate 10 underneath the first and the second conducting lines 11 and 12 in the slotline waveguide hardly influences the propagation of this slotline mode.

Due to the superposition principle, there is a second propagating mode available in the high-frequency waveguide structure, which is independent of the slotline mode. This mode is a modified co-planar waveguide mode (CPW-mode), which uses the third conducting line 13 as a signal line and the first and the second conducting lines 11 and 12 as RF ground. Thereby, this 3-conductor system has a very well defined 2-mode structure, wherein the two modes can be easily addressed and read out. With such a structure, it is possible to adapt the impedance of the two independent modes in a very flexible way by adjusting the geometric parameters of the first and second conducting lines 11 and 12 and of the third conducting line 13. For the slotline mode, the width w, the height h and a distance d between the first and the second conducting lines 11 and 12 along the layer A can be adapted.

TABLE 1
Geometric parameters of the slotline mode and the resulting Impedance.

| Width w | Distance d | Impedance Z₀ |
|---|---|---|
| [μm] | [μm] | (at 50 GHz and 500 GHz) |
| 2 | 2 | 58 Ω . . . 54Ω |
| 2 | 6 | 101 Ω . . . 98 Ω |
| 6 | 2 | 52 Ω . . . 49 Ω |

Referring to table 1, a wide range of slotline mode impedances can be achieved. For a constant height h variations of the width w and the distance d are provided and the impedance Z₀ for two frequencies at 50 GHz and 500 GHz of a propagating wave in the slotline mode are shown. Having a width w=2 μm and a distance d=2 μm, 50 GHz the impedance Z₀ is 58Ω and for the same parameter set at 500 GHz the impedance Z₀ is 54Ω. Having a width w=2 μm and a distance d=6 μm, at a frequency of 50 GHz the impedance Z₀ is 101Ω and at a frequency of 500 GHz the impedance Z₀ is 98Ω. Having a width w=6 μm and a distance d=2 μm, at 50 GHz the impedance Z₀ is 52Ω and at 500 GHz the impedance Z₀ is 59Ω.

As can be seen from table 1, the slotline mode impedance Z₀ has the advantageous property of low dispersion. This is due to the frequency independent strong confinement of the electric field, achieved by the present invention. Additionally, the loss in the first and the second conducting lines 11 and 12 is also reduced by having a high height h realized by the thick metal layer of the CMOS/BICMOS process. Preferably, the height h is in the range of 2 to 10 μm, and more preferable in the range of 2 to 5 μm.

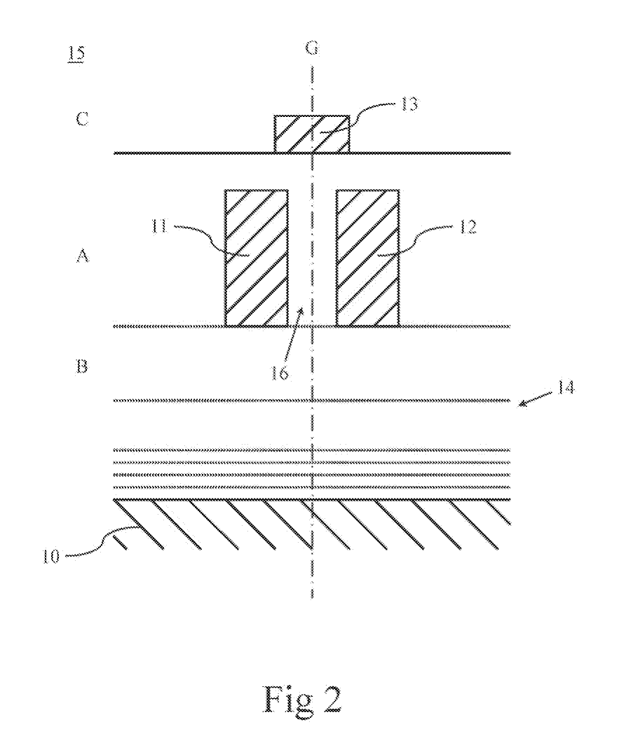

For the CPW-mode the third conducting line 13 could be located in various metal layers of the CMOS/BICMOS process. The third conducting line 13 having a width w₂ along the second layer B and perpendicular to the waveguiding direction can be adapted. For example, the third conducting line 13 can be formed in a top metal layer C of the CMOS/BICMOS process as shown in FIG. 2. The width w₂ of the third conducting line can be made wider, equal or smaller than distance d. Preferably, the distance d is smaller than, equal to or greater than the width w of the first and second conducting lines 11 and 12.

TABLE 2
Geometric parameters of the co-planar waveguide mode for
achieving a 50 Ω impedance.

| | Width w | Distance d | Width of third line w₂ |
|---|---|---|---|
| | [μm] | [μm] | [μm] |
| Option (a) | 2 | 6 | 3 |
| Option (b) | 2 | 6 | 4 |

Referring to table 2, it is also possible to achieve a 50Ω CPW mode having the following geometries. In option (a), as shown in FIG. 1, the first and the second conducting lines 11 and 12 are formed in a thick metal layer (metal layer 6) of the CMOS/BICMOS process and the third conducting line 13 is formed in a metal layer (metal layer 5) below the thick metal layer of the CMOS/BICMOS process. To achieve a 50Ω CPW mode, the width is w=2 μm, the distance of the first and the second conducting lines 11 and 12 is d=6 μm, and the width of the third conducting line 13 is w₂=3 μm. In option (b), as shown in FIG. 2, the first and the second conducting lines 11 and 12 are formed in thick metal layer (metal layer 6) and the third conducting line 13 is formed in the top metal layer. For achieving a 50Ω CPW mode, the width is w=2 μm, the distance is d=6 μm and the width of the third conducting line is w₂=4 μm.

The high-frequency waveguide structure can easily be fabricated in a CMOS/BICMOS process, comprising at least one thick metal layer and one additional metal layer. This is very common in current CMOS/BICMOS processes. Here, the first and second conducting lines 11 and 12 are formed in the same thick metal layer and the third conducting line 13 is formed in another metal layer below or above the thick metal layer. Alternatively, the third conducting line can be made in the same layer as the first and second conducting lines 11 and 12. Preferably, the first and the second conducting lines 11 and 12 are made of Cu or an alloy thereof due to its high conductivity and to reduce fabrication costs. In one aspect, the first and the second conducting lines 11 and 12 and/or the third conducting line 13 are embedded in a SiO₂-layer stack.

Alternatively, the high-frequency structure can be fabricated in any other non CMOS/BICMOS process comprising a substrate, multiple dielectric layers and one thick metal layer. The high-frequency waveguide structure can be arranged on a main group IV semiconductor substrate as the electric field is mainly confined in-between the first and the second conducting lines 11 and 12. The non-insulating main group IV semiconductor substrate 10, such as Si, underneath the first and the second conducting lines 11 and 12 and the third conducting lines 13 hardly influences the distribution of the electric field of the slotline mode. Alternatively, the substrate 10 can be any conducting (i.e. metal), any semiconducting or any insulating material.

### Diode-Bridge Structure

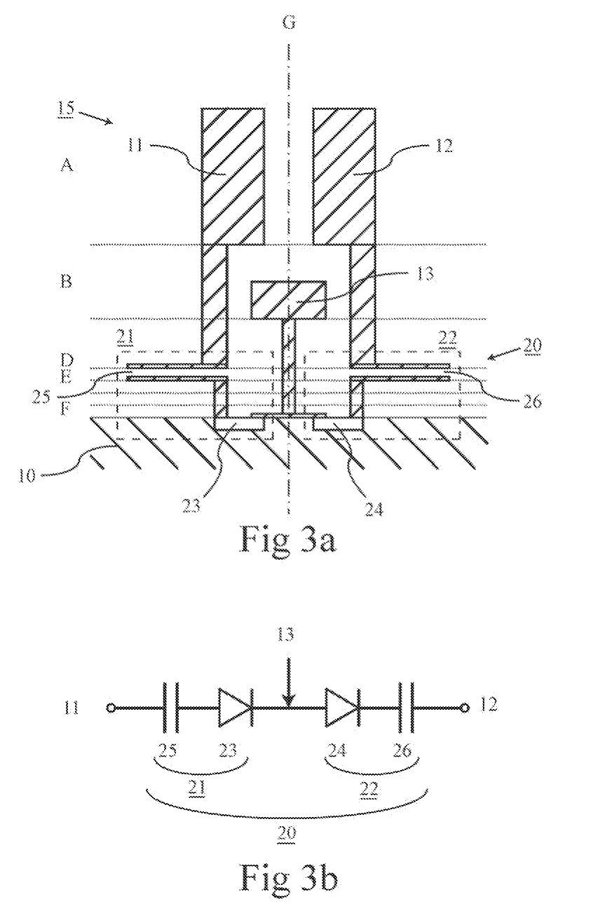

A possible use for the high-frequency waveguide structure as described above is a diode-bridge structure 20 as shown in FIG. 3a. The diode-bridge structure 20 is connected to the high-frequency waveguide structure 15 and comprises a first interconnection structure 21 and a second interconnecting structure 22. The first interconnecting structure 21 is connected between the first conducting line 11 and the third conducting line 13 and comprises a first diode 23 connected with its cathode to the third conducting line 13 and a first capacitor 25 connected in series. The second interconnecting structure 22 between the second conducting line 12 and the third conducting line 13 comprises a second diode 24 connected with its anode to the third conducting line 13 and a second capacitor 26 connected in series, as shown in FIG. 3b.

Referring again to FIG. 3a, the first and the second conducting lines 11 and 12 are located in a first layer A on the substrate 10. The third conducting line 13 is located in the symmetry plane G between the first and the second conducting lines 11 and 12 in a second layer B below the first layer A. The first and the second capacitors 25 and 26 are formed in two subsequent metal layers D, E of the CMOS/BICMOS process below the second layer B.

The first capacitor 25 is formed by a first conductor in a fourth layer D and a third conductor in a fifth layer E. The second capacitor 26 is formed by a second conductor and a fourth conductor in the fourth and fifth layers D and E, respectively. As shown in FIG. 3a, the fifth layer is E is below the fourth layer D, and the fourth layer D is below the second layer B. Therefore, the first and the second capacitors 25 and 26 are located on two intermediate metal layers D and E under the first and the second conducting lines 11 and 12, respectively. The second and the fourth conductors in the fifth layer E are connected to the first and the second diodes 23 and 24 by a two vias, respectively. The first and the third conductors in the fourth layer D are connected to the first and the second conducting lines 11 and 12 by two other vias. As the first and the second capacitors 25 and 25 are located on two metal layers under the first and the second conducting lines 11 and 12, respectively, the vias connecting the first and the second capacitors 25 and 25 to the first and the second conducting lines 11 and 12 and to the first and the second diodes 23 and 24, respectively, are very short and their inductivity component is reduced.

The first and the second diodes 23 and 24 are located in the substrate 10. The first and the second diodes 23 and 24 are connected by a fifth conductor located in a sixth layer F processed in a metal layer of the CMOS/BICMOS process. The fifth conductor connecting the first and the second diodes 23 and 24 is connected by a further via to the third conducting line 13 located in the second layer B. As the fifth conductor connecting the first and the second diodes 23 and 24 is located in a metal layer under the third conducting line 13, the via connecting the fifth conductor to the third conducting line is very short and their inductivity component is reduced.

As the first and the second conducting lines 11 and 12 forming the slotline waveguide are connected in series with the first and the second capacitors 25 and 26 to the first and the second diodes 23 and 24, respectively, a first HF (high-frequency) signal propagating in the slotline mode passes through the first and second capacitors 25 and 26 and switches the conductivity of the first and the second diodes 23 and 24. A second HF signal, present on the third conducting line 13 forming a co-planar waveguide together with the first and the second conducting lines 11 and 12 can co-propagate to the first and the second diodes 23 and 24 without coupling into the slotline mode. The second HF signal can therefore transfer a certain amount of charge onto the first and the second capacitors 25 and 26, while the first and the second diodes 23 and 24 are conducting. In this way, the signal can be read out at certain instances of time.

Preferably, the first and the second diodes 23 and 24 are Schottky diodes, as Schottky diodes have a very high switching frequency.

With the high-frequency waveguide structure, it is possible to implement the diode-bridge structure into a CMOS/BICMOS process. Previously approaches carried out in a nearly insulating GaAs substrate are not suitable for CMOS/BICMOS processes due to the conductivity of the semiconducting silicon substrate. This allows implementing the HF waveguide structure into widespread, low-cost commercial applications.

### Imaging/Spectroscopy System

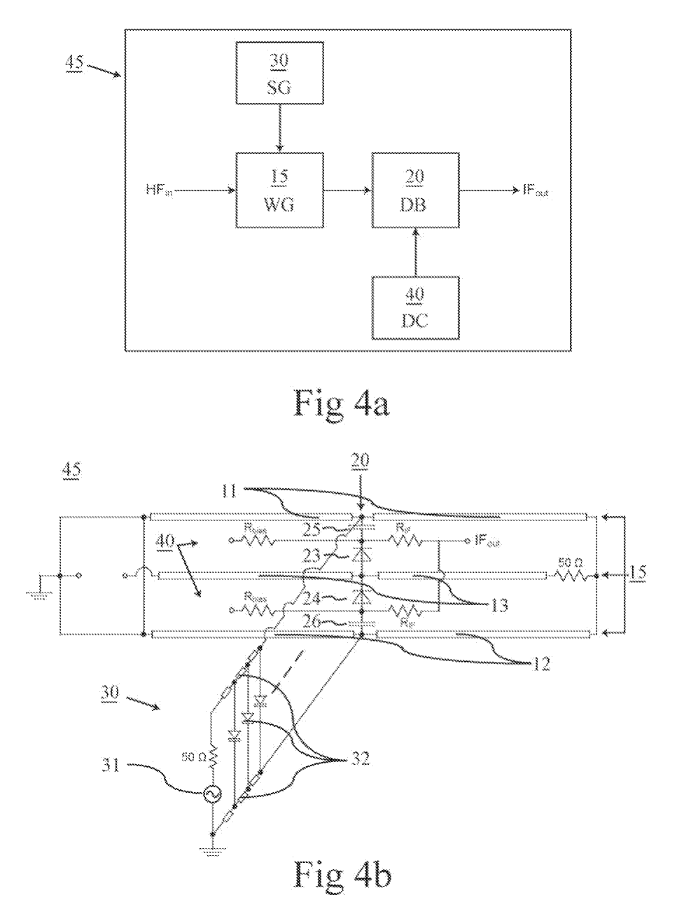

A possible application for the diode-bridge structure as shown in FIGS. 3a and 3b is an imaging/spectroscopy system as shown in FIGS. 4a and 4b for analyzing a sample using electromagnetic radiation in the sub-terahertz and/or terahertz region of the electromagnetic spectrum comprising, a transmitter for transmitting electromagnetic radiation in the sub-terahertz and/or terahertz region to the sample, and a receiver comprising a high-frequency generator and the diode-bridge structure connected to the high-frequency waveguide-structure for receiving electromagnetic radiation in the sub-terahertz and/or terahertz region from the sample.

Preferably, the transmitter generates a signal having a wide spectral content in the sub-terahertz and/or terahertz region and transmits this signal to the sample and the diode-bridge structure of the receiver is connected to the high-frequency waveguide structure for down sampling a received signal from the sample.

Preferably, the high-frequency generator comprises a nonlinear transmission line for generating a signal with a very wide spectral content, and the high-frequency generator is connected to the high-frequency waveguide structure.

Preferably, the receiver receives the signal with antennas connected to the co-planar waveguide structure as shown in FIG. 1 or 2 or through near-field coupling.

The receiver can be a sub-harmonic sampler 45 as shown in FIGS. 4a and 4b. The sub-harmonic sampler 45 schematically shown in FIG. 4a comprises a high-frequency input HFᵢₙ, a diode-bridge structure 20 connected to a high-frequency waveguide structure 15, a high-frequency generator 30, which may be realized as a strobe generator, and a DC circuit 40 and an intermediate frequency output IFₒᵤₜ.

A generated HF signal generated by the high-frequency generator 30 is connected to the slotline waveguide of the high-frequency waveguide structure 15 and the HF input signal HFᵢₙ is connected to the co-planar waveguide mode of the high-frequency waveguide structure. The DC circuit 40 controls the bias voltages of the first and the second diode 23 and 24 of the diode-bridge structure 20. The generated HF signal propagating in the slotline mode passes through the first and the second capacitors 25 and 26 and switches the conductivity of the first and the second diodes 23 and 24. The HF input signal HFᵢₙ propagates to the diode-bridge structure 20 in the co-planar waveguide mode without coupling into the slotline mode and transfers a certain amount of charge onto the first and the second capacitors 25 and 26, while the first and the second diodes 23 and 24 are conducting. In this way, the signal can be read out at certain instances of time having a lower frequency.

A circuit diagram of the sub-harmonic sampler 45 is shown in FIG. 4b. The HF input signal HFᵢₙ is connected at V_{signal} to the third conducting line 13 that is terminated with a 50Ω resistor at the opposite side of the high-frequency waveguide structure 15. The oscillator f₀ 31 is connected to a non-linear transmission line (NLTL) 32 being connected to a 50Ω impedance high frequency signal source in one signal path. The non-linear transmission line 32 comprises a plurality of waveguides having a plurality of third diodes connected in parallel and compresses a oscillator signal from the oscillator f₀ 31 into the generated HF signal (shockwave or soliton-like) with a very wide spectral content having a higher frequency than the oscillator signal. The non-linear transmission line 32 is connected to the slotline mode of the high-frequency waveguide structure 15. The non-linear transmission line 32 is composed by a linear waveguide or other suitable transmission line structures periodically loaded by non-linear capacitances, as for examples reversed biased Schottky diodes or varactor diodes. The non-linear capacitances are responsible for formation of shockwaves or solitonic pulses (with wide spectral content). The formation of such shockwaves is e.g. described in “Delta-doped Schottky diode non-linear transmission lines for 480 fs 3.5-V transients “(by D. W, van der Weide; Appl. Phys. Lett. 65, pp. 881-883, August 1994).

The DC circuit 40 comprises a first DC voltage input DC1 connected in series with a resistor R_{bias} to the first interconnecting structure 21 between the first diode 23 and the first capacitor 25 and a second DC voltage input DC2 connected in series with a resistor R_{bias} to the second interconnecting structure 22 between the second diode 24 and the second capacitor 26. The DC voltage inputs DC1 and DC2 control the bias voltage of the first and the second diodes 23 and 24, respectively. The biasing of the first and the second diodes 23 and 24 with the DC voltages DC1 and DC2 has on the one hand to be chosen such the output amplitude of the non-linear transmission line 32 is sufficiently large to drive the first and the second diodes 23 and 24 into forward bias. On the other hand it has to be chosen sufficiently low, such that the time interval of forward biasing is small enough to sample with sufficient accuracy.

The IF (intermediate frequency) output IFₒᵤₜ is connected in parallel to the first and the second interconnecting structures 21 and 22 with two resistors R_{IF} connected in series. The two resistors R_{IF} are connected in parallel between the first diode 23 and the first capacitor 25 and between the second diode 24 and the second capacitor 26, respectively.

The high-frequency generator 30 generates a high speed voltage step that is splitted at the connection point of the first and the second conducting lines 11 and 12 of the high-frequency waveguide structure 15 with the diode-bridge structure 20. The two splitted signals travel on the first and the second conducting lines 11 and 12 of the high-frequency waveguide structure 15 and are simultaneously reflected at the short circuit on either side. The sum of the incident and the two reflected voltage signals at the location of the connection point switches the first and the second diodes 23 and 24 on and off again after a short period of time T. The time interval T depends on the amplitude and fall time of the generated HF signal, on the chosen diodes, their DC bias and on a length of the first and the second conducting lines 11 and 12 along the first layer A and along the waveguiding direction.

The HF input signal HFᵢₙ that needs to be sampled is feed to the third conducting line 13 and is charging the first and the second capacitor 25 and 26 during the time that the first and the second diodes 23 and 24 are forward biased. In the embodiment of FIG. 4b the first and the second capacitors 25 and 26 are hold capacitors. Preferably, the high-frequency input signal is composed of frequency components n·f_{RF} (n=1, 2, 3, . . . ) and a sampling pulse repetition frequency is chosen as f_{RF}+Δf, with Δf/f_{RF}<<1. Due to the small frequency shift between the generated HF signal and the HF input signal HFᵢₙ, a sampling window slowly shifts over the envelope of the HF input signal HFᵢₙ in time.

In this embodiment, the first and the second diodes 23 and 24 of the diode-bridge structure 20 are high-speed diodes D1 and D2 such as high-speed Schottky diodes and the first and the second capacitor 25 and 26 are hold-capacitors. When the first and the second diodes 23 and 24 are forward baised, the HF input signal HFᵢₙ charges the hold capacitor. The charge accumulated in the hold capacitors corresponds to the average HF input signal HFᵢₙ during this short time interval. The amplitude of the HF input signal HFᵢₙ is too small to switch the first and the second diodes 23 and 24 by itself.

The IF output signal IFout of the sub-harmonic sampler 45 comprises a signal at the intermediate frequencies n·Δf. Preferably, the HF input signal HFᵢₙ is in the range of terahertz, whereas the intermediate frequency output signal is in the range of kilohertz or megahertz. The IF output signal IFₒᵤₜ is in a frequency range that can be easily processed by known CMOS/BICMOS circuits. Therefore, with the present invention all the components of a high-frequency imaging spectroscopy system can be integrated in one CMOS/BICMOS chip for a widespread, low-cost use. Compared to existing terahertz spectrometers, the proposed system is advantageous with respect to the size, the power consumption and the costs.

1. A high-frequency waveguide structure, comprising:
a substrate;
a first and a second conducting line located in a first layer (A) on the substrate; and
a third conducting line located in the symmetry plane (G) between the first and the second conducting lines wherein a height (h) of each of the first and the second conducting lines is higher than a width (w) of each of the first and second conducting lines.

2. The high-frequency waveguide structure as claimed in any one of the preceding claims, wherein the third conducting line is located in a second layer (B, C) above or below the first layer (A).

3. The high-frequency waveguide structure as claimed claim 1, wherein the first and the second conducting lines form a first waveguide for a slotline mode, and wherein the third conducting line together with the first and second conducting lines form a second waveguide for a planar waveguide-mode or a co-planar waveguide mode.

4. The high-frequency waveguide structure as claimed in claim 1, wherein the coupling between the first and the second conducting line is higher than the coupling between the first or the second conducting line to the substrate.

5. The high-frequency waveguide structure as claimed in claim 1, wherein the electric field of the slotline mode is mainly confined in-between the first and the second conducting lines.

6. The high-frequency waveguide structure as claimed in claim 1, wherein the electric field of the slotline mode is substantially zero in the symmetry plane G of the first and the second conducting lines.

7. The high-frequency waveguide structure as claimed in claim 1, wherein the high-frequency waveguide structure is integrated into a CMOS/BICMOS device.

8. The high-frequency waveguide structure as claimed in claim 1, wherein the first and the second conducting lines are formed by a patterned thick metal layer.

9. A diode-bridge structure being connected to a high-frequency waveguide structure according to claim 1, comprising:
a first interconnecting structure between the first conducting line and the third conducting line comprising a first diode being connected with its cathode to the third conducting line and a first capacitor connected in series; and
a second interconnecting structure between the second conducting line and the third conducting line comprising a second diode being connected with its anode to the third conducting line and a second capacitor connected in series.

10. The diode-bridge structure as claimed in claim 9, wherein the first and the second capacitors are located on two intermediate metal layers under the first and the second conducting lines, respectively.

11. The diode-bridge structure as claimed in claim 9, wherein the first and the second diodes are located in the substrate under the first and the second conducting lines, respectively.

12. An imaging/spectroscopy system for analyzing a sample using electromagnetic radiation in the sub-terahertz and/or terahertz region comprising:
a transmitter for transmitting electromagnetic radiation in the sub-terahertz and/or terahertz region to the sample;
a receiver comprising high-frequency generator and a diode bridge structure according to claim 9, for receiving electromagnetic radiation in the sub-terahertz and/or terahertz region from the sample.

13. The imaging/spectroscopy system as claimed in claim 12, wherein the high-frequency generator comprises a nonlinear transmission line for generating a signal with a very wide spectral content.

14. The imaging/spectroscopy system as claimed in claim 12, wherein the high-frequency generator is connected to a high-frequency waveguide structure.

15. Method for manufacturing a high-frequency waveguide structure comprising the steps of:
providing a substrate;
providing a dielectric material on the substrate;
providing a thick metal layer in a first layer (A) on the dielectric material,
processing a first and a second conducting line by structuring the thick metal layer, wherein a height of each of the first and the second conducting lines is higher than a width of each of the first and a second conducting lines; and
processing a third conducting line located in the symmetry plane (G) between the first and the second conducting lines before or after processing the first and the second conducting line.
